(19) United States
(12) Patent Application Publication
(10) Pub. No.: US 2012/0015068 A1
(43) Pub. Date: Jan. 19, 2012

(54) DEVICES FOR USE WITH MOLDED MATERIALS

(76) Inventor: Douglas P. DuFaux, Orchard Park, NY (US)

(21) Appl. No.: 13/184,561

(22) Filed: Jul. 17, 2011

Related U.S. Application Data
(60) Provisional application No. 61/365,334, filed on Jul. 18, 2010.
(60) Provisional application No. 61/365,759, filed on Jul. 19, 2010.

(51) Int. Cl. B28B 11/14; B26B 27/00

(52) U.S. Cl. 425/385; 30/116

(57) ABSTRACT

This invention provides methods and devices for modifying the shape and size of moldable materials including various types of natural and synthetic clays, edible materials such as cookie dough, and modeling compound in ways that preserves the features contained within a cross section of the moldable materials and is safe to use by children.

### PRIORITY CLAIM

This application claims priority to and incorporates herein by reference the contents of each, in their entirety, U.S. Provisional Patent Application entitled “Cutting Device for Modeling Compound” with Ser. No. 61/365,334 and filed on 18 Jul. 2010 and U.S. Provisional Patent Application entitled “Moldable Material Stamp” with Ser. No. 61/365,759 and filed on 19-Jul.-2010.

### FIELD OF THE INVENTION

The present invention relates to methods for processing and devices for use with moldable materials such as moldable clays, moldable synthetic materials, natural moldable materials, and edible moldable materials.

### BACKGROUND OF THE INVENTION

Moldable materials including various types of natural and synthetic clays, edible materials such as cookie dough, and modeling compound such as Play-Doh (Registered Trademark of Hasbro, Inc.) and Model Magic (Registered Trademark of Crayola LLC) are very popular over a wide age group. Numerous other forms of moldable materials exist.

Considering the large quantities of related products sold throughout the world, there is always a strong market pull for new, different, and unusual toys or other devices that can be used with moldable materials, especially for products targeted at children. Many parents desire for their children to play with toys that include an educational element along with a creative element. Therefore, there have been many toy devices using letters and forms to help teach children the alphabet, words, and the like. The prior art has also taught a wide variety of devices that allow children to form moldable material into a variety of shapes and objects.

Extruders are one type of toy and are used to force a relatively unshaped form of moldable material through an opening or set of openings with a die or die set to create moldable material in various cross-sectional shapes.

Various extruders for use with moldable materials have been previously described. For example, U.S. Pat. No. 3,157,933 to Boggild et al., U.S. Pat. No. 4,076,476 to Ventura, U.S. Pat. No. 6,602,066 to Heayes, and U.S. Pat. No. 7,275,924 to Kreuzer all disclose various toy extruders intended for use with soft moldable materials such as modeling compound to form strips or other elements having a variety of different cross-sections. The collective art teaches different methods for designing the extruder and that a plurality of dies may be employed to enable a child to remove and replace a die having a differently shaped opening whenever a different design or shape of molded article is desired.

In U.S. Patent Application Publication Nos. 20090311385 to DuFaux and 20090309251 to DuFaux and Belisle, each incorporated herein by reference, certain new devices and methods for forming moldable materials are disclosed. An embodiment of those applications includes methods to create forms of moldable materials that incorporate a high level of detail throughout the form, including complex forms that combine more than one color to create forms with letters, numbers, words, and other graphics. In some cases, these forms need to be cut in order to observe the detail inside of the form and/or further processed by flattening or stretching while preserving detail. Some products, such as modeling compound, are designed to be used by children and therefore need to be cut with a cutter that is safe for children. Devices that are safe to use and create modified forms and smooth cuts in the modeling compound do not exist.

### SUMMARY

It is desirable to be able to easily modify and process moldable forms to reduce the length or change the shape of the molded piece with devices that are safe to use for children. When cutting, the device needs to cut the moldable forms cleanly, such that the cut section does not deform. When modifying form, it is desirable to be able to easily compress segments of extruded materials into predetermined shapes with a device that is safe to use for children and compresses the moldable forms in a manner such that the detail of the extruded form is at least partially visible in the compressed segment.

It is therefore an object of the present invention to provide an improved cutting device for moldable materials.

It is therefore another object of the present invention to provide a compressing stamp for moldable materials.

The present invention satisfies these objectives, and provides other advantages as described herein. Improved devices for modifying molded materials are provided.

The present invention provides processes and devices for use with moldable materials such as moldable clays, moldable synthetic and natural materials, and moldable materials that are edible wherein a device of the present invention safely cuts sections of such materials in a manner such that the cut section is not significantly deformed and any detail within the cut section can be clearly observed by an operator. Further, the present invention provides processes and devices safely compresses sections of such materials in a manner such that detail that appears in the section prior to stamping is at least partially visible in the compressed section and such detail within the cut section can be clearly observed by an operator.

In a preferred embodiment, a cutting device is provided for cutting moldable materials such as moldable clays, moldable synthetic and natural materials, and moldable materials that are edible that includes a plastic support and waxed nylon filament.

In another preferred embodiment, a stamping device is provided for compressing moldable materials such as moldable clays, moldable synthetic and natural materials, and moldable materials that are edible that includes a plastic housing and a concave portion that first contacts the segment to be compressed.

### BRIEF DESCRIPTION OF THE DRAWINGS

The following detailed description of embodiments of the present invention can be best understood when read in conjunction with the following drawings, where like structure is indicated with like reference numerals and in which:

FIG. 1A is Prior Art and shows a view of a moldable material rod produced according to one embodiment of the invention and used in the creation of a moldable billet according to one embodiment of the invention.

FIG. 1B is Prior Art and shows a perspective view of a moldable material segment produced according to one embodiment of the invention and used in the creation of a moldable billet according to one embodiment of the invention.

FIG. 2A is Prior Art and shows a representation of a moldable material extrusion that contains a set of letters.

FIG. 3A is a front view and 3B is a side view of a cutting device made in accordance with an embodiment of the present invention.

FIG. 4 is the cutting device of FIG. 3 being used in accordance with an embodiment of the present invention.

FIG. 5A is a perspective view and 3B is a front view of a cutting device made in accordance with an embodiment of the present invention.

FIG. 6A is a front view and 3B is a side view of a cutting device made in accordance with an embodiment of the present invention.

FIG. 7A is Prior Art and shows a representation of a moldable material extrusion that contains a set of letters.

FIG. 7B is Prior Art and shows a representation of the moldable material extrusion if FIG. 2A after it is compressed with a flat toy stamp.

FIG. 8A is a perspective view of a stamp made in accordance with an embodiment of the present invention.

FIG. 8B is a front view of a stamp made in accordance with an embodiment of the present invention.

FIG. 8C is a sectional view of a stamp made in accordance with an embodiment of the present invention.

FIGS. 9A and 9B is an illustration of a stamp being used in accordance with an embodiment of the present invention.

### DETAILED DESCRIPTION OF EMBODIMENTS OF THE INVENTION

The present invention will now be described with occasional reference to the specific embodiments of the invention. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise. All publications, patent applications, patents, and other references mentioned herein are incorporated by reference in their entirety.

Unless otherwise indicated, all numbers expressing quantities of ingredients, properties such as weight fraction, reaction conditions, and so forth as used in the specification and claims are to be understood as being modified in all instances by the term “about.” Accordingly, unless otherwise indicated, the numerical properties set forth in the following specification and claims are approximations that may vary depending on the desired properties sought to be obtained in embodiments of the present invention. Notwithstanding that the numerical ranges and parameters setting forth the broad scope of the invention are approximations, the numerical values set forth in specific examples are reported as precisely as possible. Any numerical values, however, inherently contain certain errors necessarily resulting from error found in their respective measurements.

Devices for modifying and processing moldable forms to reduce the length or change the shape of the molded forms are provided. The devices, systems, and methods may be used to safely and easily cut and/or reduce the length of moldable materials in a way that allows detail in the moldable form to be visible after cutting and/or shaping. Moldable materials including various types of natural and synthetic clays, modeling compound, and edible materials such as cookie dough and candies, and other materials are all suitable to be used with the invention described herein. Hereinafter the term ‘moldable material’ is used generically to refer to all such materials and ‘modeling compound’ is occasionally used as a specific embodiment for convenience, but it should be noted that such embodiments are not restricted to modeling compound and may be applied to other moldable materials.

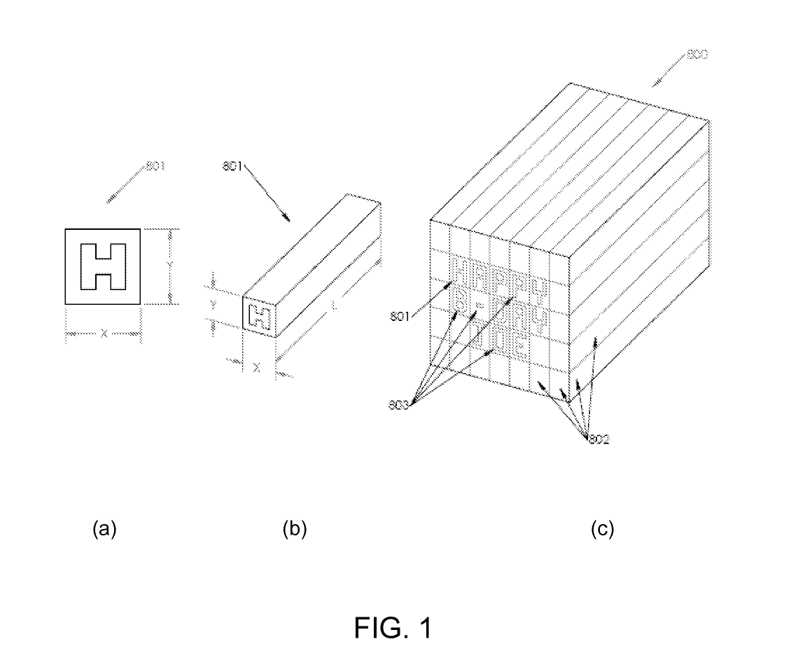

Referring now to the figures, FIG. 1 is prior art and shows a moldable material 800 created by an embodiment described in U.S. patent application Ser. No. 12/484,733 filed on 15 Jun. 2009 (the '733 application). FIG. 1(a) shows a front view of a graphic segment 801 including a letter character “H” therein that was produced through an embodiment of the '733 application. FIG. 1(b) shows a perspective view of the same graphic segment 801. The graphic segment 801 has a defined cross sectional area and in this embodiment the graphic segment 801 is generally square. The length of the graphic segment 801 is defined by the desired length of the moldable billet 800, as described in the '733 application. FIG. 1(c) shows a moldable billet 800 that includes 35 individual segments—a mix of color segments 802 and graphic segments 803; the graphic segments 803 collectively containing characters creating a textual message spelling “HAPPY B-DAY JOE” in the moldable billet 800 when viewed generally from the front. This billet 800 is compressed and the cross sectional area can be reduced in size as described in the '733 application.

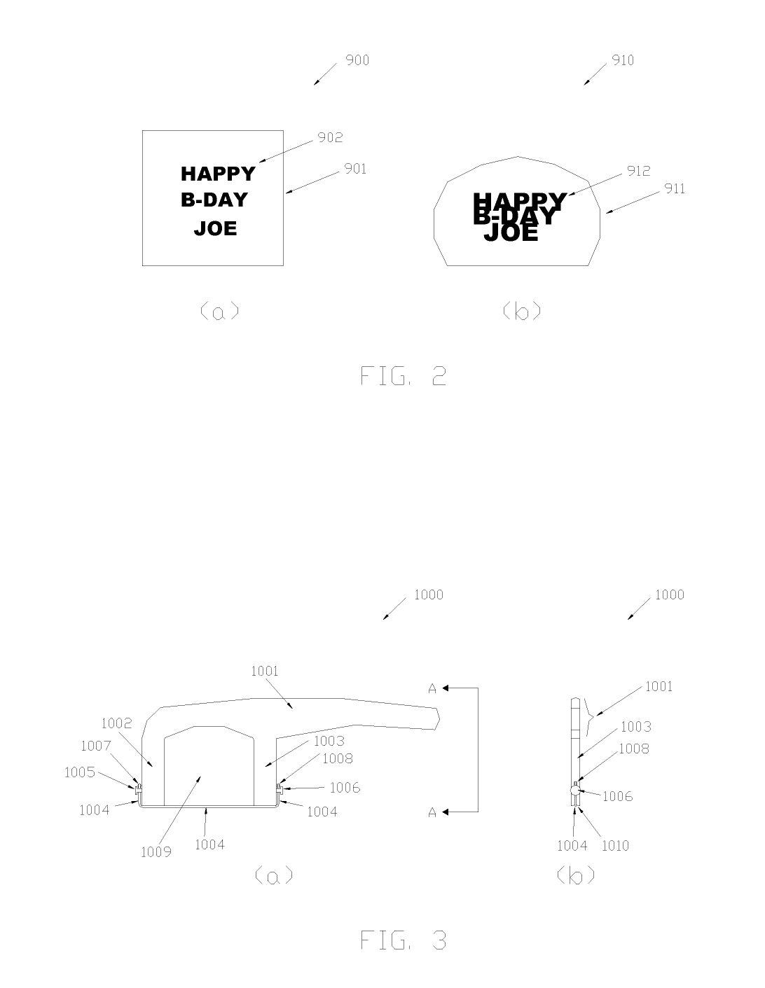

This continuous moldable form that is produced is often desired to be cut by the user, in order to produce multiple pieces that each displays the message “HAPPY B-DAY JOE,” for example. Current blade-style cutters available for use by children are not sharp due to safety concerns and greatly deform the modeling compound when used, such that the face of the newly exposed moldable material is deformed. Other cutters made for moldable materials such as scissors and press cutters deform the moldable materials to an even larger extent when compared to the blade-style cutters. FIG. 2(a) shows a representation of a front view of an extruded form 900 made from the billet 800 in FIG. 1, as described by the '733 application. The extruded form contains the message “HAPPY B-DAY JOE,” and the edges 901 of the extruded form 900 create a generally square section. The letters 902 can be clearly seen. FIG. 2(b) shows a representation of a front view of a cut extruded form 910 made from the billet 800 in FIG. 1, as described by the '733 application, after being cut by a blade-style cutter made in a manner such that it is safe to be used by children. The cut extruded form 910 has been compressed and the edges 911 of the cut extruded form 910 generally appear to be a flattened, rounded section. As a result of the compression and tearing that takes place when cut with currently available forms, the letters 912 become deformed and the message is often unreadable.

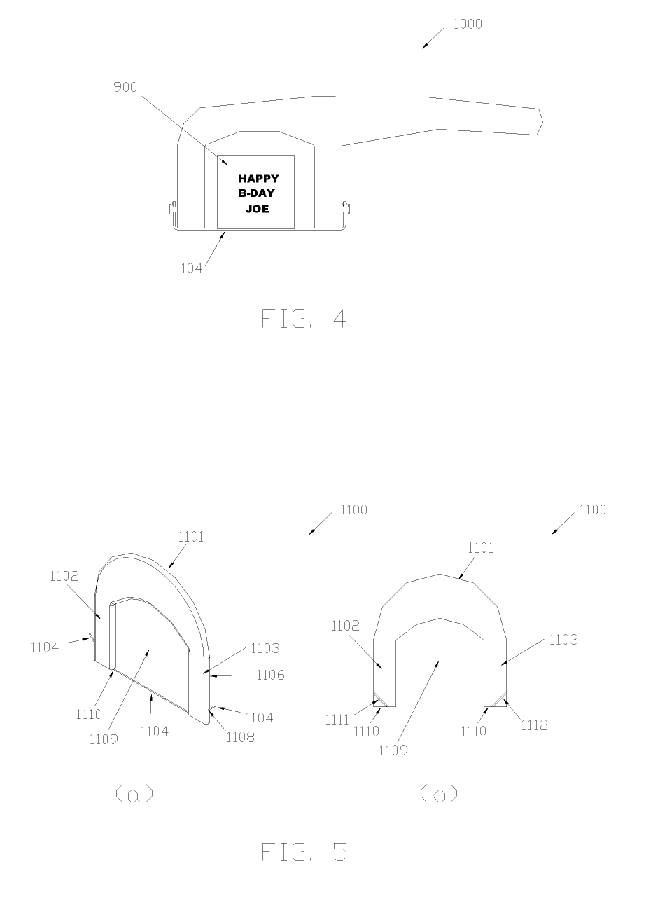

Referring now to FIG. 3 (a), the preferred embodiment of the present invention is shown. The cutting device 1000 includes a support 1001 that can be held by the hand of a user that has attached two opposing members extending outward generally parallel to each other, a left extension member 1002 and a right extension member 1003, and a filament 1004 that is stretched between the left extension member 1002 and a right extension member 1003. The cutting device 1000 further includes a left post 1005 extending from and integral to the left extension member 1002 and a right post 1006 extending from and integral to the right extension member 1003. The left post 1005 and right post 1006 serve as attachment points for the filament 1004. The filament 1004 can be tied around the left post 1005, forming a knot 1007 and tied around the right post 1006, forming a knot 1008. The space created between the support 1001, the left extension member 1002, the right extension member 1003, and the filament 1004, is the receiving void 1009, that is a clearance to ensure that the moldable material being cut is not deformed during cutting by contacting any solid material.

It is noted that the stretched filament 1004 extends past the two opposing members in the direction along the direction parallel to the left extension member 1002 and a right extension member 1003, such that the filament 1004 can completely penetrate and cut a segment of moldable material when laid on a flat surface such as a table.

FIG. 3 (b) shows the cutting device 1000 from the right side, which is indicated by the direction A-A in FIG. 3 (a), and shows the support structure 1001, the right extension member 1003, the filament 1004, the right post 1006, and the knot 1008 in the filament 1004 formed around the right post. From this view, the groove 1010 in the bottom of the right extension member 1003 (and left extension member 1002) can be seen. The groove 1010 is optional and serves as a locator for the filament 104 such that the filament 104 does not slip off the end of the left extension member 1002 and a right extension member 1003. If included, the groove 1010 should have a depth that is less than the diameter of the filament 1004, to ensure that the filament 1004 extends beyond the left extension member 1002 and a right extension member 1003 to facilitate a complete cut of a moldable material segment when the segment is laid on a flat surface.

FIG. 4 shows the cutter of FIG. 3 at the end of a cut of the extruded form 900 from FIG. 2(a), highlighting the position of the filament 104, which is at the leading edge of the cut such that a full cut of the moldable material can be accomplished. Also shown in the Fig. is a representation of the high quality of the cut made by a cutter as made in accordance with an embodiment of the present invention.

FIG. 5(a) shows a perspective view for an alternative design for a cutter. The cutting device 1100 includes a support 1101 that can be held by the hand of a user that has attached two opposing members extending outward generally parallel to each other, a left extension member 1102 and a right extension member 1103, and a filament 1104 that is stretched between the left extension member 1102 and a right extension member 1103. The cutting device 1100 further includes an optional groove 1110 at the end of the left extension member 1102 and a right extension member 1103. The filament 1104 can be fed through holes included in the left extension member 1102 and a right extension member 1103 and tied in a knot to secure the filament 104 on the cutting device 1100. The space created between the support 1101, the left extension member 1102, the right extension member 1103, and the filament 1104, is the receiving void 1109, that is a clearance to ensure that the moldable material being cut is not deformed during cutting by contacting any solid material.

FIG. 5(b) shows the cutting device 1100 from the front, including hidden lines, and shows the support structure 1101, the left extension member 102, the right extension member 1103, the groove 1110, a left feed though hole 1111, and a right feed through hole 1112. The filament 104 is not shown in this image, in order to highlight the left feed though hole 1111, and the right feed through hole 1112.

Referring now to FIG. 6(a), another embodiment of the present invention is shown. The cutting device 1200 includes a support 1201 that can be held by the hand of a user that has attached two opposing members extending outward generally parallel to each other, a left extension member 1202 and a right extension member 1203, and a filament 1204 that is stretched between the left extension member 1202 and a right extension member 1203. The cutting device 1200 further includes a left post 1205 extending from and integral to the left extension member 1202 and a right post 1206 extending from and integral to the right extension member 1203. The left post 1005 and right post 1006 serve as attachment points for the filament 1204. In this embodiment, the filament 1204 is a ribbon or sheet of thin metal or plastic. It is secured to the left post 1205 and right post 1206 though holes in the filament 1204 that are cut such that the ribbon is taught. The space created between the support 1201, the left extension member 1202, the right extension member 1203, and the filament 1204, is the receiving void 1209, that is a clearance to ensure that the moldable material being cut is not deformed during cutting by contacting any solid material.

It is noted that the filament 1204 extends past the two opposing members in the direction along the direction parallel to the left extension member 1202 and a right extension member 1203, such that the filament 1204 can completely penetrate and cut a segment of moldable material when laid on a flat surface such as a table.

FIG. 6(b) shows the cutting device 1200 from the right side, which is indicated by the direction B-B in FIG. 6(a), and shows the support structure 1201, the right extension member 1203, the filament 1204, the right post 1206, and the filament 1004 secured to the right post 1206.

The filament can be made of a small diameter wire in any material that is strong enough to be stretched across the supports without breaking or stretching. Suitable materials include metal and plastic wire. Preferably, the filament is made from a low friction plastic, including nylon, and coated nylon, such as wax coated nylon, Teflon, polyethylene or a combination thereof. Preferably, the filament is less than 2 mm in diameter, more preferably less than 1 mm in diameter, and most preferably less than 0.5 mm in diameter. The filament may also be made from a thin sheet material. Suitable materials include metal and plastic sheet or foil. Preferably, if a sheet or ribbon is used, it is made from plastic. Preferably, the ribbon is made from polyethylene, polypropylene, PVC, Teflon, ABS, or nylon. Preferably, the ribbon is less than 1 mm in thickness, more preferably less than 0.5 mm in thickness, and most preferably less than 0.25 mm in thickness.

The filament must be taught in order to provide for a clean cut. Preferably, the tension on the filament is at least 0.5 newtons and more preferably more than 4 newtons. Such tension can be imparted during manufacture by fixing one end of the filament to one of the opposing members, then pinching the members together without fracturing one or both, and then securing the other end of the filament to the opposing member. When the pinch is released, the opposing members will return to their rest position and impart some tension on the filament.

In another embodiment of the present invention, a cutting device may be motorized and include a motor, a drive shaft, and a cutting disk that makes contact with the material to be cut.

The cutting disk can be made out of any suitable material, such as metal, plastic, composite, etc. The cutting disk is preferably made of a rigid material, such as metal, hard plastic, or a strong composite material. The cutting disk may be of a serrated tooth design, or it may be of an abrasive design. If a tooth design is used, the cutting disk preferably has at least 4 teeth per cm, and more preferably at least 10 teeth per linear cm of the cutting device (for example, pi times the diameter in cm for a cutting disk). The cutting disk is preferably as thin as practically possible, to minimize the amount of candy that is removed during the cutting process. If a circular design is used, the cutting disk is rotated at about 100 rotations per minute or more, during the cutting process.

Although a circular cutting design is preferred, a linear type of cutting action may be employed as well. Many types of reciprocating type cutting mechanisms exist.

In another embodiment, material is cut using a cutting device that is brought to an elevated temperature. For example a wire may be resistively heated by connecting it to an electrical circuit such that electricity passes through the wire. Preferably this wire has a small diameter, at most about 1 mm in diameter. Larger diameter wires may be used, but they remove and/or displace excessive amounts of material during the cutting process and thus result in less finished product. Heated blades such as a razor blade, knife, roller type blade (e.g., pizza or dough cutter) may be used as well. The inventor has discovered that such designs provide for high clarity in the final product pieces.

The heated cutting device may be made of any suitable material that can withstand the required temperature and force to cut the moldable material, which will vary depending on the type of moldable material, for example by chemical composition, moisture content and/or temperature. Preferably, the material of the cutting device that comes into contact with the candy to be cut is made of metal, thermally conductive plastic, or thermally conductive composite. Preferably, any surface of the cutting device that contacts the material is smooth. The surfaces that come into contact with the material are preferably polished to a mirror finish. This can be accomplished easily, for example by mechanical polishing, electro polishing and/or chemical polishing.

Current stamps available for use by children are limited in form, such that the top of the stamp is either flat or takes the form of three dimensional body that is being created. For example, a stamp of a turtle may be constructed such that when the form is removed from the stamp, it has the overall form of a turtle. These and other stamps available in the Prior Art are not made to compress a segment of moldable material in a uniform manner.

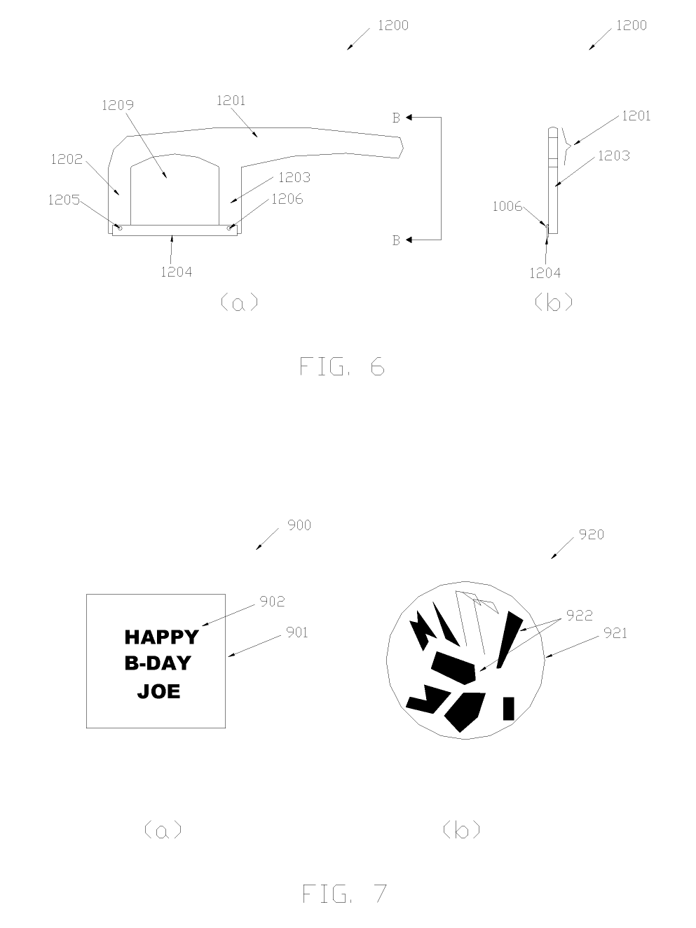

FIG. 7(a) shows a representation of a front view of an extruded form 900 made from the billet 800 in FIG. 1, as described by the '733 application. The extruded form contains the message “HAPPY B-DAY JOE,” and the edges 901 of the extruded form 900 create a generally square section. The letters 902 can be clearly seen. FIG. 7(b) shows a representation of a front view of a compressed extruded form 920, which is the extruded form 901 of FIG. 7(a) after it has been compressed with a round toy stamp with a flat surface. The edges 921 of the compressed extruded form 920 are now generally round. The compressed extruded form 920 has been compressed in a non-uniform manner and the letters 902 in the pre-compressed extruded form 900 have become deformed letters 922 and the message is often unreadable.

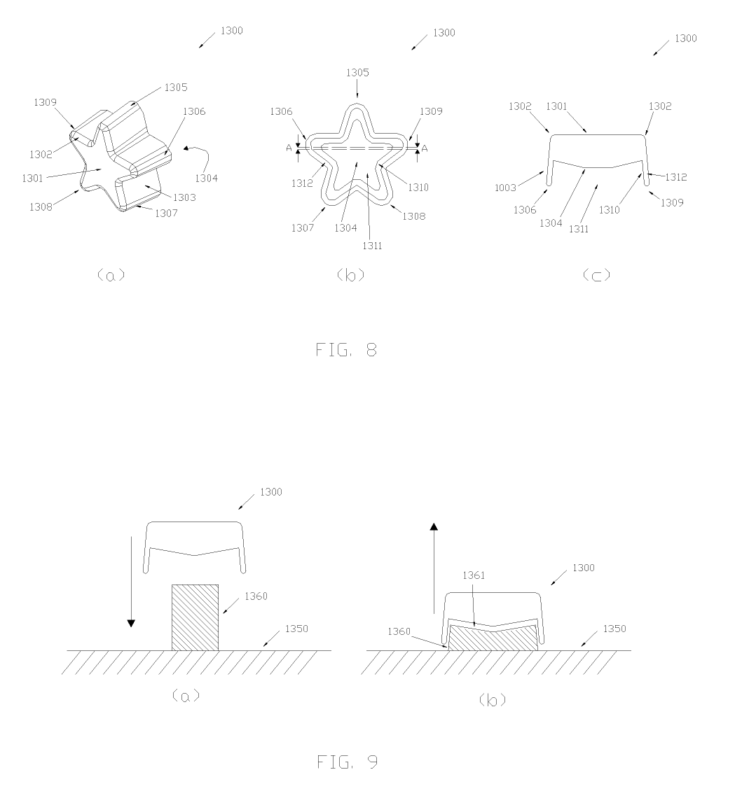

Referring now to FIG. 8 (a), an embodiment of the present invention is shown. The stamp 1300 is of a size that can be held by the hand of a user and at least 10% larger in cross section than the cross section of the segment that will be compressed with the stamp 1300. The stamp 1300 includes a rear face 1301, a front lip 1302, a wall outer face 1303, a front face 1304 (not seen in FIG. 8(a)), and five wall peaks: a first wall peak 1305, a second wall peak 1306, a third wall peak 1307, a fourth wall peak 1308, and a fifth wall peak 1309.

FIG. 8(b) is a rear view of the stamp 1300. In this view, the front face 1004 can be seen, along with the first wall peak 1305, the second wall peak 1306, the third wall peak 1307, the fourth wall peak 1308, the fifth wall peak 1309, a wall inner face 1310, a stamp cavity 1311 and a stamp wall 1312. Also shown is indicator lines A-A that indicate a section of the stamp that will be described next.

FIG. 8 (c) shows a section view of the stamp 1300. The section is indicated in FIG. 8(b) with the section A-A, and is a thin section from the second wall peak 1306 to the fifth wall peak 1309, as shown in FIG. 8(b). This view shows the rear face 1301, the front lip 1302, the wall outer face 1303, the front face 1304, the second wall peak 1306, the fifth wall peak 1309, the wall inner face 1310, the stamp cavity 1311 and the stamp wall 1312. From this view, it is clear that the stamp cavity is formed by the space created between the front face 1304, the stamp wall inner face, and a plane that extends from the tip of the walls. Preferably, the front face 1304 is a radius. Preferably, the radius of the front face 1304 is greater than 1 cm.

Referring now to FIG. 9 (a), the stamp 1300 of FIG. 3 is shown in use. For simplicity, the sectional image of the stamp 1300 shown in FIG. 8(c) is used and shown along with a flat surface 1350 such as a table top. The stamp 1300 is shown just prior to making contact with an extruded segment 1360. FIG. 9(b) shows the stamp 1300 after it has fully compressed the extruded segment 1360 (the point at which the stamp wall contacts the flat surface 1350) and has been slightly retracted by the user, which results in a small gap 1361 between the stamp 1300 and the extruded segment 1360. The extruded segment 1360 has taken the form of the stamp cavity. Because of the shape of the front face 1304, which is concave, the extruded segment 1360 has been compressed in such a way as to maintain detail.

The face of a stamp that contacts the extruded segment is concave and is preferably a simple radius. The shape of the concave surface can be adjusted to create different features in a compressed extruded segment. For example, it may be desired to compress as uniformly as possible resulting in a compressed extruded segment that maintains as much detail within the extruded segment as possible. Or, it may be desired to slightly deform the detail within the extruded segment such that information about the detail is retained, but the exact form has been lost. An example of this would be apparently stretching or squeezing letters contained in an extruded form such that the overall message is still visible to a user, in a way similar to how Fun House mirrors distort images.

### EXAMPLE

A star shaped stamp similar in shape to that shown in FIG. 8 was fabricated that had an outside diameter of 35 mm, a height of 20 mm, a maximum cavity depth of 10 mm and a concave front face that was a simple radius of 55 mm. The wall had a thickness of 1.1 mm. The wall was fabricated with a draft of 10 degrees, such that the extruded form easily slips out of the cavity after compression. It should be noted that a high draft angle is preferred for the stamps of the present invention. Preferably, the draft angle is greater than 2 degrees, more preferably greater than 5 degrees, and most preferably between 10 degrees and 20 degrees.

The stamp was used to compress an extruded form that was generally square in shape when viewed from the front, and had a cross sectional area of 1 square cm, and was 3 cm in length. The extruded form contained 4 blue letters and a yellow matrix. After compressing with the stamp, the letters were clearly visible, with some minor distortion around the outside edges of the letters. The overall form of the extruded segment after compression was similar to the star shown in FIG. 8.

Although the invention has been described with respect to specific preferred embodiments for a complete and clear disclosure, the appended claims are not to be thus limited but are to be construed as embodying all modifications and alternative constructions that may occur to one skilled in the art and which fairly fall within the basic teaching therein set forth.

What is claimed is:

1. A cutter for use with moldable materials comprising:
a support that can be held by the hand of a user that includes two opposing members extending outward generally parallel to each other;
a filament that is stretched between each of the two opposing members; and
wherein the stretched filament extends past the two opposing members in the direction along the parallel formed between the opposing members.

2. The cutter according to claim 1, wherein the filament extends past the two opposing members of the support in the direction along the parallel formed between the opposing members by at least 0.01 milimeters.

3. The cutter according to claim 1, wherein the support includes a handle.

4. The cutter according to claim 3, wherein a tension of at least 1 newton is applied to the filament.

5. The cutter according to claim 4, wherein the filament is made from nylon.

6. The cutter according to claim 5, wherein the nylon filament includes a waxed coating.

7. The cutter according to claim 4, wherein the filament is made from a low friction material, such as Teflon.

8. The cutter according to claim 4, wherein the cutter includes a generally U-shaped form for receiving the moldable form such that the structural member does not contact the form during cutting.

9. An extrusion cutting kit comprising:
at least one moldable segment selected from an assortment of moldable segments that include a cross-sectional graphic, wherein the respective cross-sectional graphic is an alphanumeric character or pictorial symbol; and
a cutter that includes a support that can be held by the hand of a user that includes two opposing members extending outward generally parallel to each other and a filament that is stretched between each of the two opposing members;

10. The kit according to claim 9 wherein the stretched filament extends past the two opposing members in the direction along the parallel formed between the opposing members, such that the filament can completely cut a segment of moldable material.

11. The kit according to claim 10, wherein the filament extends past the two opposing members of the support in the direction along the parallel formed between the opposing members by at least 0.01 milimeters.

12. The kit according to claim 11, wherein a tension of at least 1 newton is applied to the filament.

13. The kit according to claim 12, wherein the filament is made from nylon.

14. The kit according to claim 13, wherein the nylon filament includes a waxed coating.

15. The kit according to claim 12, wherein the filament is made from a low friction material, such as Teflon.

16. An extrusion cutting kit comprising:
at least one moldable segment selected from an assortment of moldable segments that include a cross-sectional graphic, wherein the respective cross-sectional graphic is an alphanumeric character or pictorial symbol;
a cutter that includes a support that can be held by the hand of a user that includes two opposing members extending outward generally parallel to each other and a filament that is stretched between each of the two opposing members; and
A stamp for use with moldable materials that includes a body; a cavity formed by an outer wall and a face, wherein the face is concave.

17. The kit according to claim 16, wherein the concave face of the stamp is a radius.

18. The kit according to claim 17, wherein the radius is at least 1 cm.

19. The kit according to claim 18, wherein the stamp is made from a low friction material, such as Teflon.

20. The stamp according to claim 19 wherein the center of the radius of the stamp is located at the geographical center of the stamp.

21. The kit according to claim 20, wherein the filament is made from nylon.
